(19) United States
(12) Patent Application Publication
(10) Pub. No.: US 2020/0174150 A1
(43) Pub. Date: Jun. 4, 2020

(54) POWER-EFFICIENT TRANSIENT ELECTROMAGNETIC EVALUATION SYSTEM AND METHOD

(71) Applicant: Baker Hughes, a GE Company, LLC, Houston, TX (US)

(72) Inventors: Stanislav Forgang, Houston, TX (US); Babak Kouchmeshky, Houston, TX (US); Sushant Dutta, Houston, TX (US); Randy Gold, Houston, TX (US)

(73) Assignee: Baker Hughes, a GE Company, LLC, Houston, TX (US)

(21) Appl. No.: 16/204,626

(22) Filed: Nov. 29, 2018

(51) Int. Cl. G01V 3/28; E21B 49/00; E21B 47/00

(52) U.S. Cl. CPC G01V 3/28; E21B 47/00; E21B 49/00

(57) ABSTRACT

A system for performing downhole logging operations includes a power supply for providing a current and a conductor coil electrically coupled to receive the current from the power supply. The system further includes a switch electrically coupled to the power supply for controlling current provided to the conductor coil and enabling a pulse of current to be supplied to the conductor coil for an “on” duration and turning off current provided to the conductor coil for an “off” duration after the “on” duration, in which the “off” duration lasts longer than the “on” duration. The system also includes a permanent magnet coupled to the conductor coil. The conductor coil receives the pulse of current from the power supply during the “on” duration and not receiving current during the “off” duration. The pulse of current causes the permanent magnet to reverse polarity and generate a transient magnetic field.

### BACKGROUND

1. Field of Invention

This disclosure relates in general to oil and gas tools, and in particular, to power-efficient systems and methods for performing transient electromagnetic well evaluation.

2. Description of the Prior Art

During oil and gas operations, various measurement may be conducted downhole in order to evaluate one or more formation properties. In some applications, transient electromagnetic technology may be used to measure electrical properties of the formation. In conventional transient electromagnetic technology, an electromagnet with switchable polarity is used to induce transient magnetic fields in the surrounding formation. A constant current is continuously applied to the electromagnet for a relatively long period of time to maintain its magnetization, and then the current is abruptly switched off or the polarity of the current is reversed. The electromagnet is then maintained in the switched off state or in the reversed polarity state for a period of time long enough to obtain desired properties of investigated medium. The electromagnet may then be turned on again or polarity switched again and maintained unchanged until the next switching occurs. The electromagnet may be continuously switched back and forth during a measurement operation. The abrupt switching of the electromagnet, either between on/off states or polarities, results in corresponding abrupt switching of the corresponding magnetic field interacting with the investigated formation. This time-varying magnetic field of electromagnet generates a transient electromotive force in the formation which, in turn, produces eddy currents in the formation. The eddy currents induce their own magnetic signal that can be measured and processed for obtaining information about the electrical properties of the formation.

The eddy currents induced in the formation by the abrupt electromagnet switching begin to decay after the switching occurs and the rate of this decay depends on the electromagnetic properties of the formation. The decaying eddy currents produce a corresponding magnetic field, which can be measured by a receiver. The output of the receiver thus contains information of the formation electromagnetic properties. During this measurement phase, the current applied to the electromagnet remains shut off or unreversed as the formation is responding to every change in this current, which may convolute the measured data if left uncontrolled. Thus, in conventional transient electromagnetic technology, in order to establish a condition in which the measured data is accurate and robust, a constant current is continuously applied to the electromagnet for a relatively long time, which results in high power consumption. For example, when a conventional polarity switching is used, a current is applied for substantially 100% of operation time. Even in the case of on/off switching, the current is applied for substantially at least 50% of the time.

### SUMMARY

Applicant recognized the problems noted above and conceived and developed embodiments of systems and methods for power-efficient transient electromagnetic well logging.

In an embodiment, a system for performing downhole logging operations includes a power supply for providing a current and a conductor coil electrically coupled to receive the current from the power supply. The system further includes a switch electrically coupled to the power supply for controlling current provided to the conductor coil and enabling a pulse of current to be supplied to the conductor coil for an on duration and turning off current provided to the conductor coil for an “off” duration after the on duration, in which the “off” duration lasts longer than the “on” duration. The system also includes a permanent magnet coupled to the conductor coil. The conductor coil receives the pulse of current from the power supply during the “on” duration and not receiving current during the “off” duration. The pulse of current causes the permanent magnet to reverse polarity and generate a transient magnetic field. The system further includes a receiver detecting an electromagnetic signal caused by eddy currents in a surrounding environment induced by the transient magnetic field.

In another embodiment, a system for performing downhole logging operations includes a power supply for supplying power in pulses as controlled by a switching mechanism, in which off periods in-between the pulses last longer than the pulses. The system further includes a conductor coil electrically coupled to the power supply and receiving a current from the power supply during the pulses. The system also includes a permanent magnet positioned with respect to the conductor coil such that each pulse of current causes the permanent magnet to reverse polarity and induce a transient magnetic field in surrounding structures. The system further includes a receiver configured to detect an electromagnetic signal caused by eddy currents induced by the transient magnetic field.

In an embodiment, a method for evaluating a well includes the placing an evaluation tool in a wellbore surrounded by a well formation, in which the evaluation tool includes a permanent magnet coupled to a power supply, applying a pulse of current from the power supply to a conductive coil coupled to the permanent magnet. The pulse of current is applied for an “on” duration to reverse the polarity of the permanent magnet and generate a transient magnetic field in the well formation. The method further includes turning off the current supplied to the conductive coil after the “on” duration for an “off” duration, in which the “off” duration is longer than the “on” duration. The method further includes measuring, during the off duration, an electromagnetic signal caused by eddy currents in the formation induced by the transient magnetic field.

### BRIEF DESCRIPTION OF THE DRAWINGS

The present technology will be better understood on reading the following detailed description of non-limiting embodiments thereof, and on examining the accompanying drawings, in which:

FIG. 1 illustrates a cross-sectional elevation view of an embodiment of a wellbore system, in accordance with embodiments of the present disclosure.

FIG. 2 illustrates an embodiment of a coil configuration of a transient electromagnetic wellbore evaluation tool, in accordance with embodiments of the present disclosure.

FIG. 3 illustrates another embodiment of a coil configuration of a transient electromagnetic wellbore evaluation tool, in accordance with embodiments of the present disclosure.

FIG. 4 is a block diagram representation of a wellbore evaluation system, in accordance with embodiments of the present disclosure.

FIG. 5A is a graph representing an excitation current applied a permanent magnet of a wellbore evaluation tool with respect to time, in accordance with embodiments of the present disclosure.

FIG. 5B is a graph representing a magnetization of the permanent magnet of the wellbore evaluation tool with respect to time, in accordance with embodiments of the present disclosure.

FIG. 5C is a graph representing a transient voltage signal induced in a receiver by the conductor coil and the permanent magnet of the wellbore evaluation tool, as well as the eddy currents, with respect to time, in accordance with embodiments of the present disclosure.

FIG. 6 is a flowchart representing an example method of well evaluation, in accordance with embodiments of the present disclosure.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

In various embodiments, like components may be referred to with the same reference numerals throughout the specification. However, in certain embodiments, different reference numerals may be used for clarity. Additionally, components of a similar nature may be referred to with a reference numeral and a letter, such as A and B, for clarity, and should not be construed as limiting. For example, while similar components may be referred to with reference numerals and an associated A and B, there components may have different sizes, shapes, or different operational mechanisms.

Embodiments of the present disclosure include systems and methods for performing transient electromagnetic logging with low power consumption. As discussed, previous transient electromagnetic techniques utilize electromagnets which allow for polarity switching, but also require a current to be constantly applied to maintain the magnetization of the electromagnet. The presently disclosed systems and methods provide for a switchable permanent magnet, which only requires a very short pulse of current to switch the polarity of the magnet and does not require any power to maintain that magnetization between switching. Thus, the total power consumption of the evaluation tool is significantly decreased.

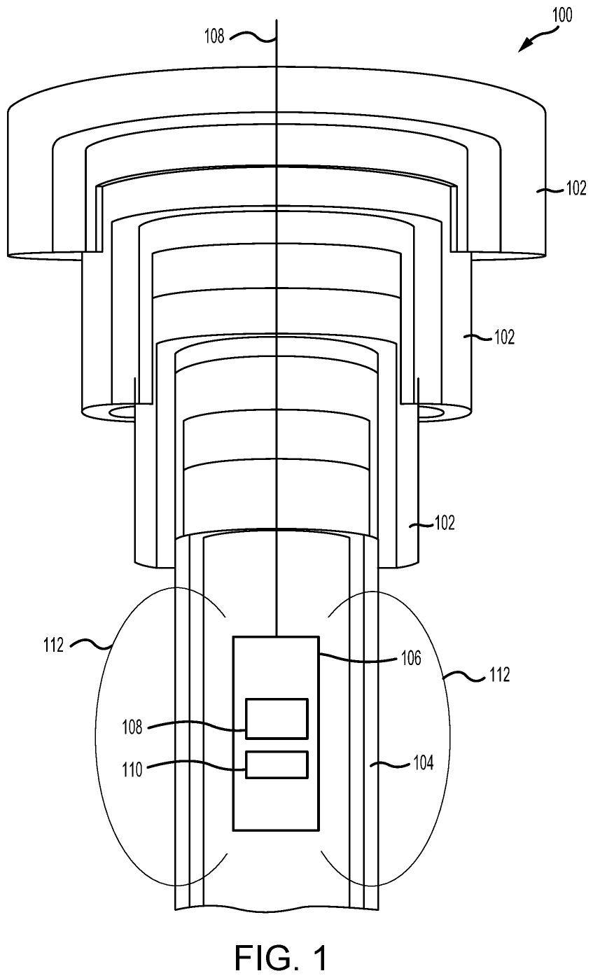

FIG. 1 is a partial cross-sectional view of a well integrity inspection system, illustrating a well formation 100, including one or more structures surrounding a wellbore. The well formation 100 may include structures such as tubing, casing, cement layers, and earth. Specifically, in some embodiments, the well formation 100 may be formed into the earth and include an internal production pipe 104, a series of cylindrical metal casings 102, and cement wall layers between the casing layers 102. In some embodiments, the well 100 may not include all of these structures. For example, the well may not be cased and thus not include casing or cement wall layers. The well 100 may be any type of well, including but not limited to conventional and unconventional hydrocarbon producing wells. The well 100 may be a surface well or a subsea well.

An evaluation tool 106 may be deployed downhole into the well 100 to perform various logging functions and collect data on the well formation 100. In various embodiments, the evaluation tool 106 is a transient electromagnetic evaluation tool that can be used to determine electrical properties of the well formation 100. The evaluation tool 106 includes a transmitter portion for generating excitations signals and a receiver portion for measuring signals induced by the excitation signals. More specifically, the evaluation tool 106 generates a transient magnetic field in the well formation 100, inducing eddy currents in the well formation. The eddy currents induce an electromagnetic signal, which is detected by the receiver, and the detected electromagnetic signal contains information about the well formation 100. In various embodiments, the evaluation tool 106 includes a permanent magnet, and the transient magnetic field is generated when the polarity of the permanent magnet is abruptly reversed. The transient magnet field begins to decay after the polarity is reversed, during which the measurement can be made. The polarity of the permanent magnet can be switched back and forth at a specified rate during a logging operation. In various embodiments, the polarity of the permanent magnet is reversed when a high amplitude pulse of current is applied to a conductor coil positioned relative to the permanent magnet to induce the magnetization direction of the permanent magnet. The short pulse of current has a high enough amplitude to momentarily demagnetize the permanent magnet and then re-magnetize the permanent magnet when the current is removed or decreased. The magnetization of the permanent magnet remains constant after the current is removed. The direction in which the permanent magnet is re-magnetized depends on the polarity of the current. The polarity of the applied current is chosen such that the permanent magnet is re-magnetized to the opposite polarity it was before the current was applied. Thus, to switch the polarity of the magnet back and forth, the pulses of current are applied with alternating polarity.

In various embodiments, the permanent magnet is selected or configured to have a magnetization strength less than the magnetization saturation of the target structure. For example, if the evaluation system is used to evaluate the internal pipe 104 of the well formation, the permanent magnet may have a magnetization strength below the magnetic saturation of the internal pipe 104. If the evaluation tool is used to evaluate an outer pipe 102 with an inner pipe layer (e.g., internal pipe 104) situated between the outer pipe 102 and the permanent magnet, then the magnetization strength of the permanent magnet may be selected or configured to exceed the magnetic saturation of the internal pipe 104 and be lower than the magnetic saturation of the outer pipe 102. Thus, the inner pipe 104 essentially becomes “transparent” to the magnetic field, and the collected measurements will be attributed to the outer pipe. In this or similar fashions, the evaluation tool may be used to inspect individual structures in wells having any number of structures and layers.

The evaluation tool 106 may be a part of a work string 108. The work string 108 may be conveyed into the wellbore from a surface location. In various embodiments, the work string 108 includes a conveying member, such as an electric wireline, and the evaluation tool 106 may be attached to the bottom end of the wireline. In the illustrated embodiment, the evaluation tool is arranged in a vertical portion of the wellbore, however it should be appreciated that the evaluation tool may also be deployed in substantially horizontal or deviated segments of the wellbore. In some example embodiments, the wireline 108 may include an armored cable that includes conductors for supplying electrical energy (power) to downhole devices and communication links for providing two-way communication between the evaluation tool 106 and surface devices. In aspects, a processor, such as a microprocessor, a storage device, such as a memory device, and programs and instructions, may be utilized in and with the evaluation tool 106 to facilitate the functions of the evaluation tool 106. The evaluation tool 106 may include various other sensors, measurement devices, communication devices, and the like for carrying out these and other purposes and features of the evaluation tool 106.

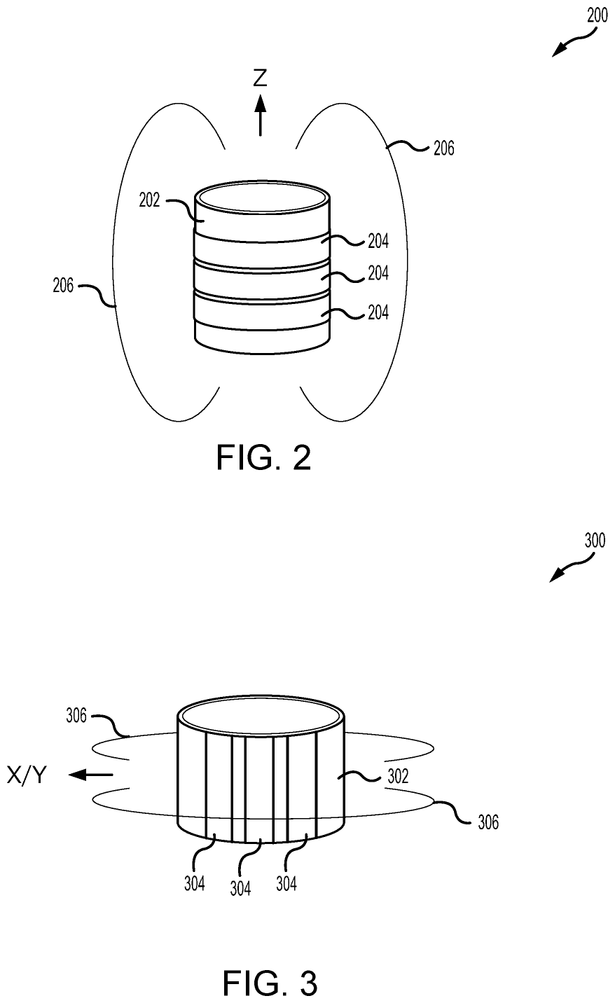

FIG. 2 illustrates an embodiment of a permanent magnet and coil configuration 200 for a downhole evaluation tool, in accordance with embodiments of the present disclosure. Specifically, FIG. 2 illustrates an embodiment of the permanent magnet 202 and coil 204 for generating a longitudinal (i.e., axial) magnetic field 206. Thus, when the evaluation tool is downhole, the magnetic field is oriented in the axial direction (Z) and longitudinal with respect to the wellbore

FIG. 3 illustrates another embodiment of a permanent magnet and coil configuration 300 for the downhole evaluation tool, in accordance with embodiments of the present disclosure. Specifically, FIG. 3 illustrates an embodiment of a permanent magnet 302 and coil 304 for generating a transverse magnetic field 306. Thus, when the evaluation tool is downhole, the magnetic field is oriented in the transverse direction (X or Y, depending on the orientation) with respect to the wellbore. In some embodiments, the evaluation tool may include more than one magnet configured to generate multiple magnetic fields and in different orientations. For example, the evaluation tool may include permanent magnets to generate both an axial magnetic field and a transverse magnetic field. The permanent magnet may be any type of material with intrinsic magnetic properties, and able to retain magnetism and generate a substantially steady magnetic field without being powered. The conductor coil may be positioned in various other ways other than the two example shown in FIGS. 2 and 3. For example, the coil 406 may be wrapped around the permanent magnet, embedded within the permanent magnet, or otherwise positioned in proximity to the permanent magnet to be able to induce demagnetization and re-magnetization of the permanent magnet.

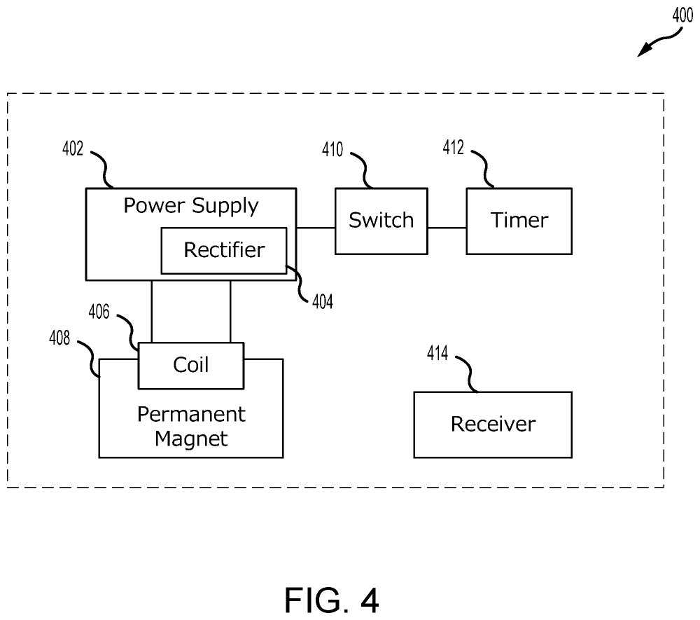

FIG. 4 is a block diagram representation of a wellbore evaluation system 400, in accordance with embodiments of the present disclosure. In various embodiment, a system for performing downhole logging operations includes a power supply 402 for providing a current and a conductor coil 406 electrically coupled to receive the current from the power supply 402. The system 400 further includes a permanent magnet 408 coupled to the conductor coil 406. For example, the coil 406 may be wrapped around the permanent magnet 408, embedded within the permanent magnet 408, or otherwise positioned in proximity to the permanent magnet 408 to be able to induce demagnetization and re-magnetization of the permanent magnet 408. In some embodiments, the conductor coil 406 may be wrapped around the magnet in various configurations and variable number of loops. The permanent magnet 408 may be any type of material with intrinsic magnetic properties, and able to retain magnetism and generate a substantially steady magnetic field without being powered.

In some embodiments, the current supplied to the conductor coil 406 is a direct current. The power supply 402 may include or is coupled to a rectifier 404, the rectifier 404 rectifying a received current into a direct current for supplying through the conductor coil 406. In various embodiments, the permanent magnet 408 may be selected based on the intended application of the system 400, such as the evaluation target. Specifically, as described above, the evaluation system 400 may be used to make measurement of a target structure of a well formation. Thus, the permanent magnet 408 is selected or configured to have a magnetization strength less than the magnetization saturation of the target structure. For example, if the evaluation system is used to evaluate an internal pipe of the well formation, the permanent magnet 408 may have a magnetization strength below the magnetic saturation of the internal pipe. If the evaluation system 400 is used to evaluate an outer pipe with an inner pipe layer situated between the outer pipe and the permanent magnet, then the magnetization strength of the permanent magnet 408 may be selected or configured to exceed the magnetic saturation of the inner pipe and be lower than the magnetic saturation of the outer pipe. Thus, the inner pipe essentially becomes “transparent” to the magnetic field, and the collected measurements will be attributed to the outer pipe.

The system further includes a switch 410 electrically coupled to the power supply 402 for controlling current provided to the conductor coil 406. The switch 410 controls the power supply 402 to apply current in short pulses to switch the polarity of the permanent magnet 408, and keeps the current off in between pulses. In some embodiments, current is applied during “on” durations and turned off during “off” durations. In various embodiments, the “off” durations are significantly longer than the “on” duration. For example, one pulse of current may be applied approximated every second, with each “on” duration lasting only approximately 10 microseconds and no power being applied to the permanent magnet for each remaining “off” duration. When the polarity of the permanent magnet 408 is switched, a transient magnetic field may be induced in a nearby or surrounding formation or structure. In order to switch the polarity of the permanent magnet 408, the applied current has a large enough amplitude to generate a magnetic field exceeding the permanent magnet's existing magnetization. In some embodiments, the applied current may have high enough amplitude to bring the permanent magnet to or beyond its Curie point, thereby momentarily causing the permanent magnet to lose its previous magnetization and allowing it to be re-magnetized based on the polarity of the applied current. Thus, to switch the polarity of the magnet, the applied current has a polarity that will allow the permanent magnet become re-magnetized in the intended polarity. For example, in order to switch the polarity of the magnet with each excitation current, the polarity of the applied current is also switched for each excitation.

In some embodiments, the system 400 may include a timer 412 coupled to or included in the switch 410. The timer may be programmed to activate the switch based on a programmed activation rate or a control signal. In some embodiments, a processor, such as a microprocessor, a storage device, such as a memory device, and programs and instructions, may be utilized in and with the system 400 to facilitate the functions of the system. The system 400 may include various other sensors, measurement devices, communication devices, and the like for carrying out these and other purposes and features of the system 400.

The system further includes a receiver 414 detecting an electromagnetic signal caused by eddy currents in a surrounding environment induced by the transient magnetic field. The switching of the polarity of the permanent magnet 408 may induce a transient magnet field in a nearby or surrounding formation or structure. The transient magnet field begins to decay after the polarity switching, which may induce eddy currents in the formation or structure. The eddy currents then generate an electromagnetic signal, which can be detected by the receiver and used to form data regarding the formation or structure. In some embodiments, the receiver 414 may include an antenna such as a coil for detecting electromagnetic signals.

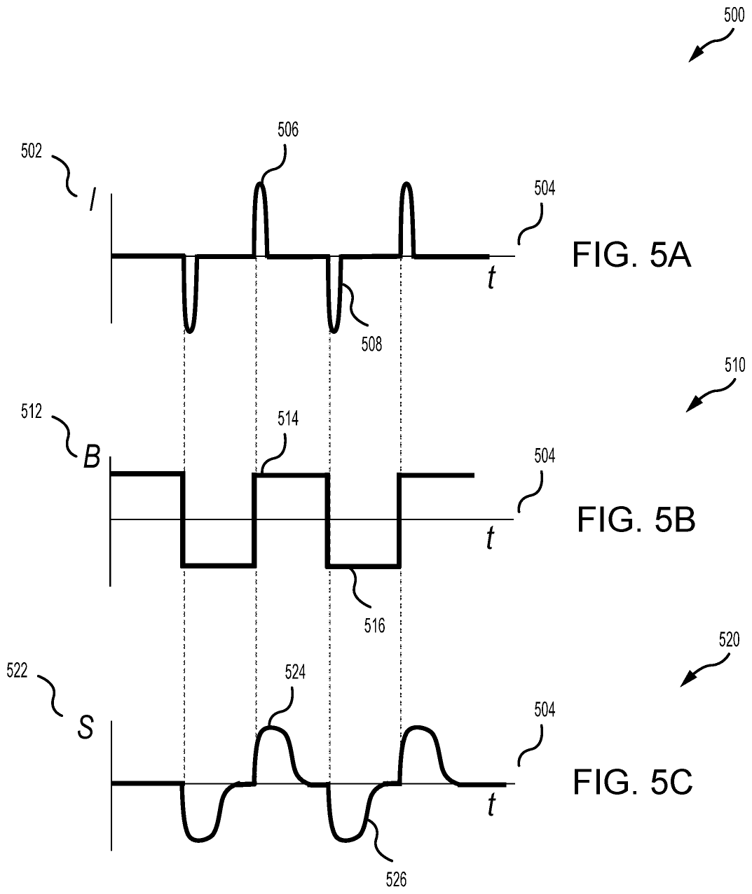

FIGS. 5A, 5B, and 5C are graphs illustrating an well evaluation scenario sharing a common time domain Specifically, FIG. 5A is a graph 500 representing an excitation current 502 applied a permanent magnet of a wellbore evaluation tool with respect to time 504, in accordance with embodiments of the present disclosure. FIG. 5B is a graph 510 representing a magnetization 512 of the permanent magnet of the wellbore evaluation tool with respect to time 504, in accordance with embodiments of the present disclosure. FIG. 5C is a graph 520 representing a transient magnetic field 522 induced by the permanent magnet of the wellbore evaluation tool with respect to time 504, in accordance with embodiments of the present disclosure. In this example, as illustrated in FIG. 5A, a current pulse 506 of a first polarity is applied at t_{S1}. The current is applied as a very short pulse (e.g., lasting 10 microseconds). Thus, in some embodiments, the duration of the applied current may be considered an instantaneous pulse. After the pulse 506, the current or power supplied is 0. Referring to FIG. 5B, at substantially t_{S1}, when the pulse of current is applied, the magnetization polarity is reversed. Once the magnetization polarity is reversed, the magnetization 514 remains constant even when the power is off and there is no current. Referring to FIG. 5C, once the magnetization polarity is reversed, a transient magnetic field 524 is induced and begins to decay. Measurements are made during this period. Referring to FIG. 5A, subsequently, another current pulse 508 may be applied at t_{S2}. The subsequent current pulse 508 applied at t_{S2} has the opposite polarity as the previous current pulse 506 applied at t_{S2}. Thus, referring to FIG. 5B, when the subsequent current pulse 508 is applied, the magnetization 504 is again reversed and remains constant until another current pulse is applied. Referring to FIG. 5C, when the magnetization is reversed at t_{S2}, another transient magnetic field 526 is induced and begins to decay. The transient magnetic field 526 also has the opposite polarity as the previously induced transient magnetic field 524. Thus, more measurements can be made during this period.

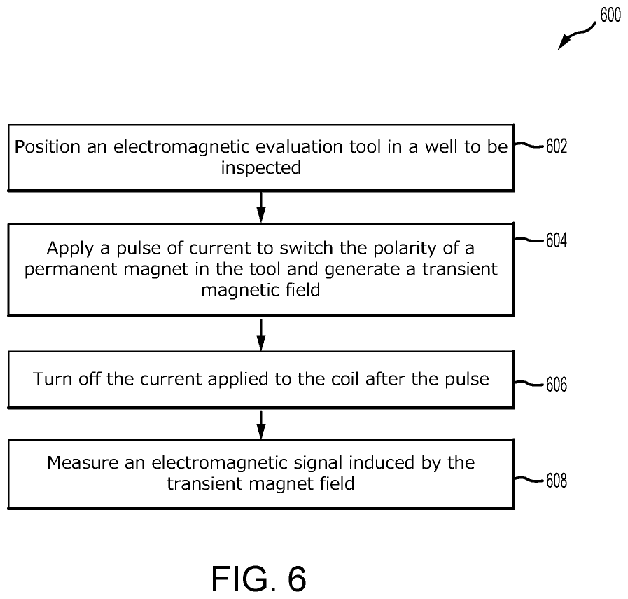

FIG. 6 is a flowchart representing an example method of well evaluation, in accordance with embodiments of the present disclosure. It should be appreciated for this method and all methods described herein that the steps may be performed in any order, or in parallel, unless otherwise explicitly stated. Moreover, there may be more or fewer steps and certain steps may be omitted, in certain embodiments. In this example of a method of evaluating a well, an evaluation tool is placed (block 602) in a well to be inspected. Specifically, the evaluation tool may be placed downhole in the wellbore surrounded by a well formation. The well formation may include pipes, casing, concrete layers, and earth, among any other structures related to the well. The evaluation tool may include a permanent magnet and a conductive coil electrically coupled to a power supply, in which the polarity of the permanent magnet is switchable by applying a high enough current through the conductive coil from the power supply.

The evaluation tool may be used to make measurement of a target structure of the well formation, and the permanent magnet has a magnetization strength less than the magnetization saturation of the target structure. For example, the evaluation tool may be used to evaluate an internal pipe of the well formation. In this application, the permanent magnet may be selected or configured to have a magnetization strength below the magnetic saturation of the internal pipe. The evaluation tool may also be used to evaluate multi-barrier structures. For example, the target structure may be an outer pipe with an inner pipe layer situated between the outer pipe and the evaluation tool. In this application, the magnetization strength of the permanent magnet may be selected or configured to exceed the magnetic saturation of the inner pipe and be lower than the magnetic saturation of the outer pipe. Thus, the inner pipe essentially becomes “transparent”, and the collected measurements will be attributed to the outer pipe. In some embodiments, the evaluation tool may be a part of a logging tool such as a wireline logging tool. It may also be a part of a drill string for logging while drilling applications.

In order to generate an excitation signal to induce a transient magnetic field in the well formation, a pulse of current is applied (block 604) through the coil from the power supply to switch the polarity of the permanent magnet. When the polarity is switched, a transient magnetic field may be induced in the well formation. The applied current has an amplitude large enough to generate a magnetic field exceeding the permanent magnet's existing magnetization. In some embodiments, the applied current may have high enough amplitude to bring the permanent magnet to or beyond its Curie point, thereby momentarily causing the permanent magnet to lose its previous magnetization and allowing it to be re-magnetized based on the polarity of the current. Thus, to switch the polarity of the magnet, the applied current has a polarity that will allow the permanent magnet become re-magnetized in the intended polarity. For example, in order to switch the polarity of the magnet with each excitation, the polarity of the applied current is also switched for each excitation. Further, for each excitation, the current is applied for a very short duration, or “on” duration to reverse the polarity of the permanent magnet. In some embodiments, the “on” duration is only as long as is needed to reverse the polarity of the permanent magnet.

After the polarity of the permanent magnet is reversed, the current applied to the permanent magnet is turned off (block 606) for an “off” duration. The “off” duration, during which power is not applied to the permanent magnet, is typically longer than the “on” duration, during which power is applied. For example, in some embodiments the “off” duration may last at least ten times as long as the “on” duration, or pulse. During the “off” duration, the transient magnet field decays and eddy currents are induced in the formation by the transient magnetic field. The eddy currents cause an electromagnetic signal, which is measured (block 608) and used to form the logging (e.g., well evaluation) data. In some embodiments, additional measurements may be made either in the same position or at another position in the wellbore by applying another current to the permanent to again reverse its polarity to generate another transient magnetic field. In some embodiments, the pulses of current can be applied at a predetermined rate. For example, one pulse of current may be applied approximated every second, with each “on” duration lasting only approximately 10 microseconds and no power being applied to the permanent magnet for each remaining “off” duration.

The analysis below illustrates an example of the power savings achieved using an embodiment of the present disclosure. Consider a conventional electromagnet for generating a dipole moment pₘ=500 Am². The conventional electromagnet would consist of N turns of copper wire around a core of soft magnetic material such as ferrite. Let the length of the core be t=1 m, and cross-section area of the core be s=0.006 m². Let the effective susceptibility of the core be χ_{eff}=150. Let an electric current l flow in the coil. Then the applied external magnetic field on the core is given by

$${H}_{e} = I \frac{N}{l} .$$

The magnetization of the core is given by

M=χ_{eff} Hₑ.

The dipole moment is given by

pₘ=Msl=χ_{eff} Hₑsl=χ_{eff}INs.

The conventional electromagnet is typically turned on and off using a switch. Let the switching time be τ_{sw}=5 μs. Then, the maximum voltage across the coil is given by

$${V}_{max} = L \frac{dI}{dt} {\vert}_{max} \approx L \frac{2 I}{{τ}_{sw}}$$

where L is the coil inductance given by

$$L \approx {μ}_{0} {χ}_{eff} \frac{{N}^{2} s}{l} .$$

Using the above equations, the current in the coil can be derived as

$$I = \frac{2 {μ}_{0} {p}_{m}^{2}}{{χ}_{eff} {τ}_{sw} s {lV}_{max}} .$$

The power losses associated with the above current are the loss in the antenna coil wire (negligible for a low inductance coil) and the loss due to finite conductivity of the switch in the conductive state. Further, since the switching phase is much shorter than the steady-state on-state, the power losses during the switching phase can be neglected. Thus, the power requirement for the conventional electromagnet is given by

P_{electromagnet}≈VₒₙIη

where Vₒₙ is the on-state voltage of the switch and η is the duty-cycle (on-state/total period). The following practical numbers are used for the current and power calculations: dipole moment pₘ=500 Am², core length l=1 m, core cross-section area s=0.006 m², effective susceptibility of the core χ_{eff}=100, switching time τ_{sw}=5 μs, maximum voltage Vₘₐₓ=1000 V, on-state voltage (for the Advanced Power Technology IGBT APT75GP120B2 as an example of a solid-state switch) Vₒₙ=3.9 V, and duty-cycle η=0.5. This results in

I≈209 Amp

P_{electromagnet≈}408 W.

Turning now to the effects of the techniques of the present disclosure, consider a switchable permanent magnet, in accordance with various embodiments, in which the power losses exist only during switching the polarity of the magnetic dipole. During the long steady-state phase, the dipole moment is maintained by the residual magnetization of the magnetic core. For a simplified ideal hysteresis loop (M=±Mₛ@H=0 and H=±H_{c}@M=0, where Mₛ is the saturation magnetization and H_{c} is the coercive force),

$${p}_{m} = 2 {M}_{s} sl = 2 \frac{{B}_{s}}{{μ}_{0}} sl .$$

Assuming Bₛ=1 T and pₘ=500 Am² (same as in the conventional magnet scenario above), and assuming l=1 m, this results in s=0.0003 m² and Mₛ=800 kA/m. The coercive force is given by

$${H}_{c} \geq \frac{{M}_{s}}{{χ}_{eff \vert max}} .$$

Assuming χ_{eff}=100, this results in H_{c}=8 kA/m. Then the minimum energy expended while switching the polarity of the switchable permanent magnet is given by

E=2μ₀MₛH_{c}sl.

The results in E=4.8 J. Then the power consumption is given by

$${P}_{switchable magnet} = \{ \begin{matrix}4.8 W & if switching rate \text{:} 1 \text{/} sec \\ 48 W & if switching rate \text{:} 10 \text{/} sec \\ 480 W & if switching rate \text{:} 100 \text{/} sec\end{matrix}$$

Comparing P_{switchable magnet} to P_{electromagnet}, it is apparent that the switchable permanent magnet yields significant power savings over the electromagnet provided the switching rate is low enough.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A system for performing downhole logging operations, the system comprising:
a power supply for providing a current;
a conductor coil electrically coupled to receive the current from the power supply;
a switch electrically coupled to the power supply for controlling current provided to the conductor coil and enabling a pulse of current to be supplied to the conductor coil for an “on” duration and turning off current provided to the conductor coil for an “off” duration after the “on” duration, the “off” duration lasting longer than the “on” duration;
a permanent magnet coupled to the conductor coil, the conductor coil receiving the pulse of current from the power supply during the “on” duration and not receiving current during the “off” duration, wherein the pulse of current causes the permanent magnet to reverse polarity and induce a transient magnetic field in a surrounding environment; and
a receiver detecting an electromagnetic signal caused by eddy currents in the surrounding environment induced by the transient magnetic field.

2. The system of claim 1, further comprising:
a timer coupled to the switch, the timer activating the switch based on a programmed activation rate or a control signal.

3. The system of claim 1, wherein the current supplied to the conductor coil has an amplitude large enough to generate a magnetic field exceeding the permanent magnet's existing magnetization.

4. The system of claim 1, wherein the current supplied to the permanent magnet is a direct current.

5. The system of claim 4, wherein the power supply includes or is coupled to a rectifier, the rectifier rectifying a received alternating current into the direct current.

6. The system of claim 1, wherein the permanent magnet has a magnetization strength below the magnetic saturation of a structure in the surrounding environment.

7. The system of claim 1, wherein the permanent magnet has a magnetization strength exceeding the magnetic saturation of a first structure in a surrounding environment and below the magnetic saturation of a second structure in the surrounding environment.

8. A system for performing downhole logging operations, the system comprising:
a power supply for supplying power in pulses as controlled by a switching mechanism, wherein off periods in-between the pulses last longer than the pulses;
a conductor coil electrically coupled to the power supply and receiving a current from the power supply during the pulses; and
a permanent magnet positioned with respect to the conductor coil, wherein each pulse of current causes the permanent magnet to reverse polarity and induce a transient magnetic field.

9. The system of claim 8, further comprising:
a receiver configured to detect an electromagnetic signal caused by eddy currents induced by the transient magnetic field.

10. The system of claim 8, wherein each pulse of current has an amplitude large enough to generate a magnetic field exceeding the permanent magnet's existing magnetization.

11. The system of claim 8, wherein the permanent magnet has a magnetization strength below the magnetic saturation of a structure in a surrounding environment.

12. The system of claim 11, wherein the permanent magnet has a magnetization strength exceeding the magnetic saturation of a first structure in the surrounding environment and below the magnetic saturation of a second structure in the surrounding environment.

13. The system of claim 8, wherein the electromagnetic signal detected during the off period is used to generate logging data.

14. The system of claim 8, wherein the off periods last at least ten times as long as the pulses.

15. A method for evaluating a well comprising:
placing an evaluation tool in a wellbore surrounded by a well formation, the evaluation tool comprising a permanent magnet coupled to a power supply;
applying a pulse of current from the power supply to a conductive coil coupled to the permanent magnet, the pulse of current applied for an “on” duration to reverse the polarity of the permanent magnet and generate a transient magnetic field in the well formation;
turning off the current supplied to the conductive coil after the “on” duration for an “off” duration, wherein the “off” duration is longer than the “on” duration; and
measuring, during the “off” duration, an electromagnetic signal caused by eddy currents in the formation induced by the transient magnetic field.

16. The method of claim 15, further comprising:
applying pulses of current to the conductor coil at a predetermined rate.

17. The method of claim 15, further comprising:
evaluating a structure of the well formation, wherein the permanent magnet has a magnetization strength below magnetic saturation of the structure.

18. The method of claim 17, wherein the structure is a pipe in the well formation.

19. The method of claim 17, wherein the magnetization strength of the permanent magnet exceeds the magnetic saturation of a second structure, the second structure being closer to the evaluation tool.

20. The method of claim 15, wherein the current supplied to the permanent magnet has an amplitude large enough to generate a magnetic field exceeding the permanent magnet's existing magnetization.
